(19) United States
(12) Patent Application Publication
(10) Pub. No.: US 2025/0004712 A1
(43) Pub. Date: Jan. 2, 2025

(54) EFFICIENT COMPUTATION OF ROLLING WINDOW STATISTICS

(71) Applicant: NVIDIA Corporation, Santa Clara, CA (US)

(72) Inventors: Ariel Szapiro, Kfar Neter (IL); Arye Albahari, Kiryat Motzkin (IL)

(21) Appl. No.: 18/342,523

(22) Filed: Jun. 27, 2023

(51) Int. Cl. G06F 7/22

(52) U.S. Cl. CPC G06F 7/22

(57) ABSTRACT

Apparatuses, systems, and techniques for efficient computation of rolling window statistics. A first value of a plurality of values bounded by a range of values is received. The first counter corresponds to a first counter of a plurality of counters, and each counter of the plurality of counters corresponds to a respective value within the range of values. In response to reception of the first value, the first counter is reset, and each of the other counters of the plurality of counters is updated. A minimum value or a maximum value within a window of most recently received value of the plurality of values is determined using the plurality of counters.

### TECHNICAL FIELD

At least one embodiment of the present disclosure pertains to processing resources used to perform and facilitate efficient computation of rolling window statistics according to various novel techniques described herein.

### BACKGROUND

Many modern computing systems can continually track data and make determinations based on data. Various implementations of digital circuits (e.g., counters), data structures, and the like can be utilized to track data. The amount of memory, time, or computing resources used to track data can be improved.

### BRIEF DESCRIPTION OF THE DRAWINGS

The present disclosure is illustrated by way of example, and not by way of limitation, in the figures of the accompanying drawings.

FIG. 1A is a block diagram of an implementation of a system illustrating an example of a technique for efficient computation of rolling window statistics, in accordance with at least one embodiment of the present disclosure.

FIG. 1B is a block diagram of an implementation of a system illustrating another example of a technique for efficient computation of rolling window statistics, in accordance with at least one embodiment of the present disclosure.

FIG. 1C is a block diagram of an implementation of a system illustrating another example of a technique for efficient computation of rolling window statistics, in accordance with at least one embodiment of the present disclosure.

FIG. 2 is a block diagram illustrating updating counters based on input values received from an input stream, according to at least one embodiment of the present disclosure.

FIG. 3 is a block diagram of a hardware implementation of a system configuration, in accordance with at least one embodiment of the present disclosure.

FIG. 4 depicts a flow diagram of an example method of efficient computation of rolling window statistics, in accordance with at least one embodiment of the present disclosure.

FIG. 5 depicts a diagram of an example computer system in which embodiments of the present disclosure may operate.

### DETAILED DESCRIPTION

Some systems can monitor a stream of data inputs (e.g., values, signals, etc.) at high frequencies (e.g., 10 gigahertz (GHz) or more) and determine statistics (e.g., a minimum value, a maximum value, etc.) of values received over a given window (e.g., 10,000 clock cycles). For example, modern computer systems may use hardware and/or software to manage power and performance of devices (e.g., processors, controllers, peripheral devices, etc.) using dynamic voltage and frequency scaling (DVFS). DVFS systems can monitor a stream of values where each value in the stream of values corresponds to a computational demand level of a device executing a given workload. The computational demand level can be represented by metrics such as a central processing unit (CPU) utilization level, a power consumption level, memory usage, input/output (I/O) activity, a temperature level, and/or the like. DVFS system can dynamically adjust voltage and frequency of the device based on statistics (e.g., a minimum value, a maximum value, etc.) of the stream of values over a given window (e.g., 10,000 cycles). Because DVFS systems can be sensitive to extreme inputs (i.e., high inputs and/or low inputs), the capability to track and analyze computational demand levels (e.g., CPU utilization levels) over a large window is a desired feature. Various other systems may similarly track and make determinations based on a stream of received values. In another example, some traffic management systems may receive streams of data from various sensors, cameras, and other sources, including information about traffic flow, accidents, and road conditions. Based on statistical analysis of this data, traffic management systems can determine how to manage traffic, prevent vehicle congestion, etc. In yet another example, stock market trading systems may receive a constant stream of input data associated with the stock market, including stock prices, trading volume, and the like. Based on this data, stock market trading systems can make determinations on whether to buy, sell, or hold certain securities. Accordingly, many modern systems utilize hardware and/or software to track and perform statistical analysis on streams of data (values) over a given window.

Conventional systems process a stream of values by maintaining a buffer to temporarily hold the stream of values received within a window of time or a window of received values. For example, the buffer can be implemented as a first-in-first-out (FIFO) queue that holds values most recently received by the system within a certain time frame where the first value added to the buffer is the first to be removed from the buffer. To compute statistics associated with the values currently in the buffer, the system can traverse the entire buffer to identify each value currently stored in the buffer. For example, the buffer may maintain 10,0000 elements to track a rolling window of 10,000 values of the most recently received values of a stream of values. To determine a minimum value currently stored within the buffer, the system can iterate over, access, and process each of the 10,000 elements of the buffer. Because the window is a rolling window, the last element of the buffer is removed when a new element is inserted into the buffer. Thus, when a new value is received, the system may again iterate over, access, and process each of the 10,000 elements of the buffer to determine an accurate minimum value currently stored in the buffer. When a system receives and processes a stream of values at a high frequency (e.g., 10 gigahertz), repeatedly traversing a large (e.g., 10,000 elements) buffer of most recently received values can introduce significant computational overhead and memory overhead to the system, which can decrease an overall frequency of the system and increase an overall latency of the system.

Aspects and implementations of the present disclosure address the above and other deficiencies by introducing a technique that reduces computational overhead and memory overhead associated with receiving, monitoring, and performing statistical computations on a rolling window (referred to as “window” herein for sake of brevity) of values. In at least one embodiment, the introduced technique allows a system (e.g., a computing system) to leverage multiple counters to track a window of a stream of values, such as and without limitation, a stream of values associated with computational demand levels of a given workload of a device for performing DVFS. The window of the stream of values may be a subset of values defined within the stream of values. In at least one embodiment, the window is a rolling window in that it may be a window of a fixed number of values that shifts as new values are received from the stream values and old values are removed from the window. For example, the rolling window may represent 10,000 of the most recently received values from the stream of values. When a new value is received, the rolling window is adjusted to include the new value and exclude the oldest value. It can be noted that, in at least one embodiment, the rolling window can represent values included in statistical computations (e.g., minimum, maximum, etc.) described herein.

The system can be operatively coupled to receive, as input, a respective value from the stream of values at every clock cycle of the system. The stream of values may be constrained by an exclusive list of possible values that may be received. For example, the stream of value may be bounded by a range of possible values from one to four. The system may maintain a respective counter for each value defined by the range of possible values. For example, the system may maintain a first counter corresponding to an input value of one, a second counter corresponding to an input value of two, a third counter corresponding to an input value of three, and a fourth counter corresponding to an input value of four.

The counters may be initialized to a certain value. In at least one embodiment, the counters may be initialized to a value corresponding to the size of the rolling window. For example, each of the four counters may be initialized to a value of 10,000, where 10,000 is the size of the rolling window. Individual values may be received sequentially from a stream of values. In some instances, the stream of values may be steadily received according to a clock cycle generated by a clock (e.g., clock circuit, oscillator, etc.) of a system. For example, a value may be received at each clock cycle (e.g., on a rising edge, a falling edge, etc.) of the clock. Each of the four counters may be updated for each value received. In at least one embodiment, the counter corresponding to the value received can be reset to a designated value, and each of the other counters can be decremented. In at least one embodiment, the designated value corresponds to the window size (e.g., 10,000). For example, a first value received from the stream of values may be a one. Accordingly, a count of the first counter may be reset to 10,000 and a count of each of the other counters may be decremented to 9,999. A two may be subsequently received from the stream of values. Accordingly, the count of the first counter may be decremented to 9,999, the count of the second counter may be reset to 10,000, the count of the third counter may be decremented to 9,998, and the count of the fourth counter may be decremented to 9,998. Thus, the counters may represent how recently a corresponding value has been received. For example, if the count of the first counter is zero, the first counter may represent that a value of one has not been received from the stream of values within the last 10,000 clock cycles. In another example, if the count of the second counter is 9,999, the second counter may represent that a value of two was received from the stream of values at the previous clock cycle. Accordingly, if a count of a respective counter is nonzero, the corresponding value has been received within the rolling window (e.g., the last 10,000 cycles). If the count of the respective counter is zero, the corresponding value has not been received within the last 10,000 cycles.

Aspects and implementations of the present disclosure can leverage the above-described counters for efficient computation of rolling window statistics. The system can determine a minimum and/or maximum value received within the rolling window (e.g., within the last 10,000 clock cycles) based on the counters. In an illustrative example, the first counter (corresponding to a value of one) may indicate a count of zero, the second counter (corresponding to a value of two) may indicate a count of 5,000, the third counter may indicate a count of 10,000, and the fourth counter may indicate a count of zero. Because the count of the first counter is zero and the count of the fourth circuit is zero, it can be determined that a value of one and a value of four have not been received from stream of values within the last 10,000 clock cycles. Accordingly, the minimum value received from the stream of values within the last 10,000 clock cycles is the lowest value corresponding to a counter with a nonzero count. Thus, the minimum value received within the last 10,000 clock cycles is two as the count of the first counter is zero and the count of the second counter is 5,000. Similarly, the maximum value received from the stream of values within the last 10,000 clock cycles is the highest value corresponding to a counter with a nonzero count. Thus, the maximum value received with the last 10,000 clock cycles is three, as the count of the fourth counter is zero, and the count third counter is 10,000.

Advantages of the disclosed embodiments over existing technology and conventional methods include increasing a window of values of a stream of values that can be considered for computational statistics without increasing consumption of computational resources, which can increase an overall efficiency and decrease an overall latency of the system, thereby improving performance. Additionally, aspects and implementations of the present disclosure can save a significant amount of memory without compromising accuracy by maintaining one or more counters to efficiently compute statistics (e.g., minimum, maximum, etc.) over a rolling window rather than traversing a large (e.g., 10,000 elements) buffer of input values.

It should be noted that various aspects of the above-referenced methods and systems are described in detail herein by way of example, rather than by way of limitation. The embodiments and examples provided herein may reference various applications of the disclosed technique for the purpose of simplicity and brevity only. However, embodiments and examples of the present disclosure can be applied to various applications that monitor a stream of data, whether at a hardware level or a programmatic level.

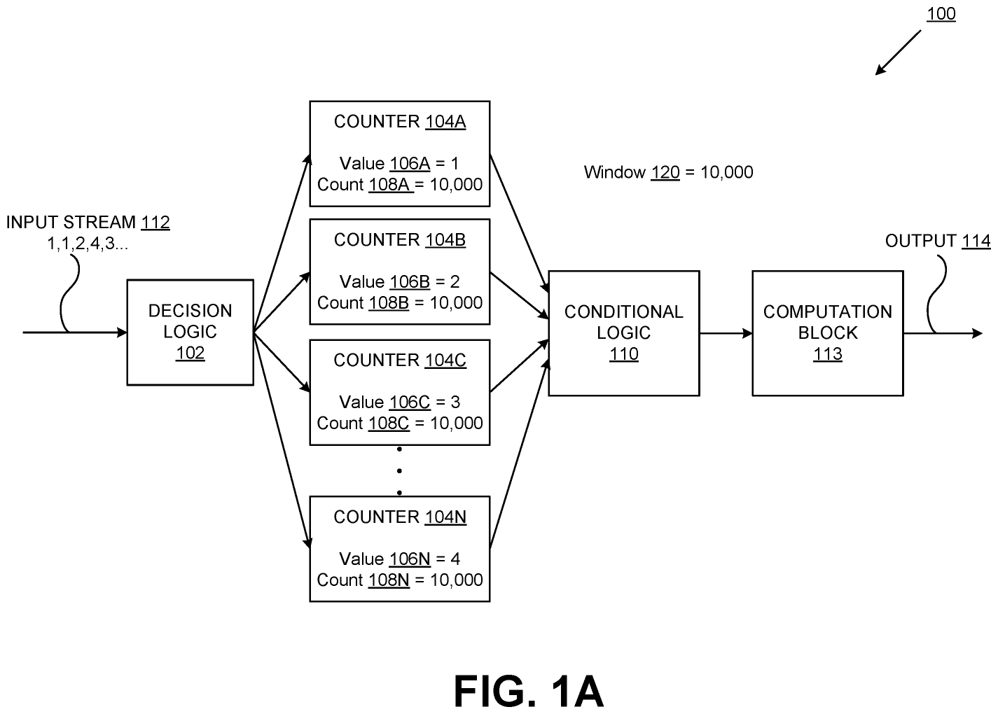

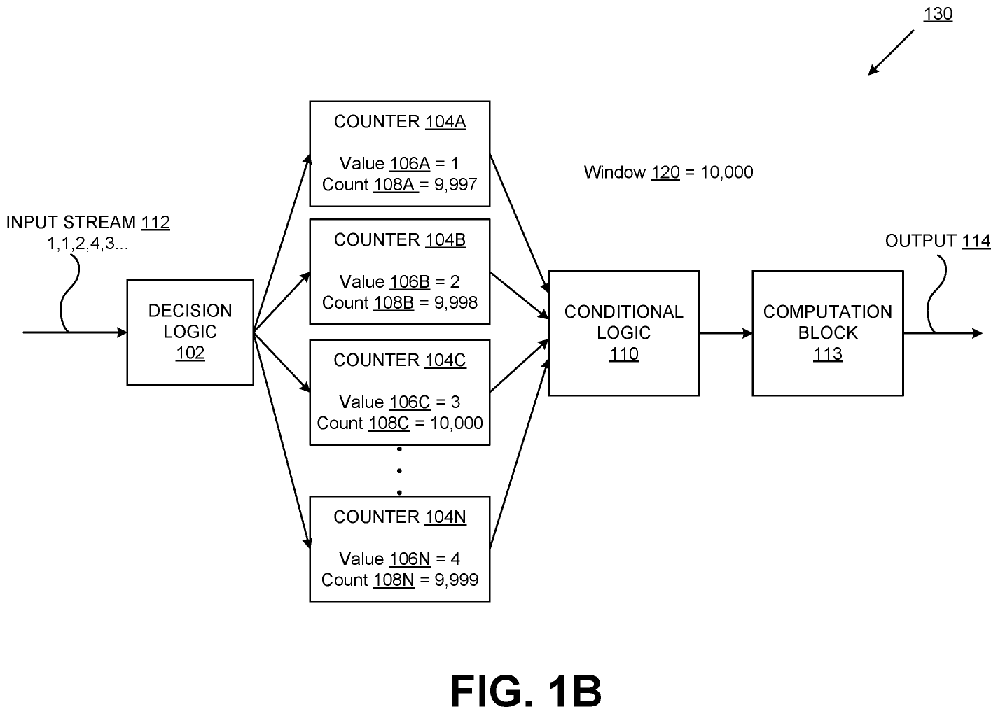

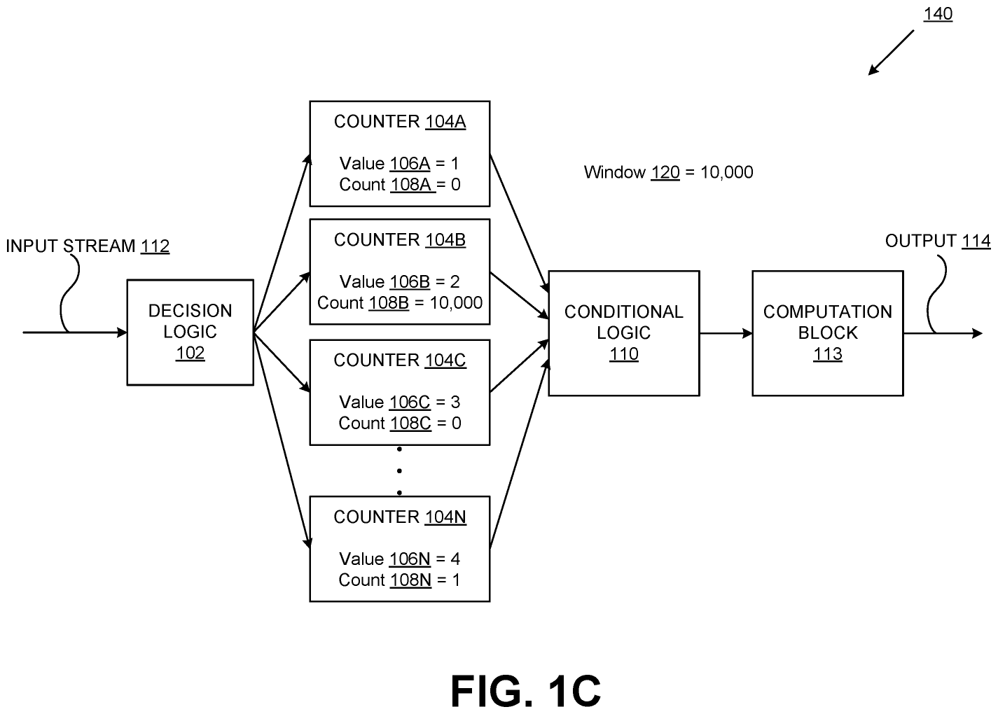

FIG. 1A is a block diagram of an implementation of a system 100 illustrating an example of a technique for efficient computation of rolling window statistics, in accordance with at least one embodiment of the present disclosure. Illustrated are decision logic 102, counter 104A-104N, conditional logic 110, and a computation block 113. The decision logic 102 is operatively coupled to receive input stream 112. In at least one embodiment, input stream 112 may be a stream of data, such as a stream of input values. The decision logic 102 can sequentially receive and process individual input values from the input stream 112. In at least one embodiment, input values within the input stream 112 may be constrained by an exclusive list of possible values. For example, the input stream may be bounded by a range of possible values from one to four. As illustrated by FIG. 1A, the first five values of the input stream 112 may be 1, 1, 2, 4, and 3. It can be noted that input stream 112 is illustrated as a stream of integers by way example, and not by way of limitation. However, it is appreciated that the integers of input stream 112 may represent data of many forms, including numbers, text, images, etc., and may originate from a variety of sources, such as sensors, databases, computing engines (e.g., a deep learning accelerator (DLA)), memory devices (e.g., volatile memory, non-volatile memory, etc.), and the like.

Each of the counters 104A-104N may track and correspond to a respective input value within the input stream 112. For example, counter 104A may track an input value 106A of “1,” counter 104B may track an input value 106B of “2,” counter 104C may track an input value 106C of “3,” and counter 104N may track an input value 106N of “4.” It is appreciated that counters 104A-104N can be implemented as software, firmware, hardware (e.g., using a series of flip-flops, programmable logic devices (PLDs), field-programmable gate arrays (FPGAs), dedicated counter integrated circuits (ICs), etc.) or the like. The counters 104A-104N may be initialized to a certain count 108A-108N. In at least one embodiment, the count 108A-108N may be initialized to a value corresponding to window 120 (also referred to as “rolling window 120” herein). For example, counters 104A-104N may be initialized to a count of 10,000, where 10,000 is the size of the window 120. The system 100 may receive and process individual input values from the input stream 112. In some instances, individual input values may be received according to a clock cycle generated by a clock (not illustrated) of the system 100. For example, an input value may be received from input stream 112 at each clock cycle (e.g., on a rising edge, a falling edge, etc.) of the clock. Responsive to receiving a clock signal from the clock, each of the counters 104A-104N may decrement a respective count 108A-108N of the counters 104A-104N beginning from the initialized value (e.g., 10,000).

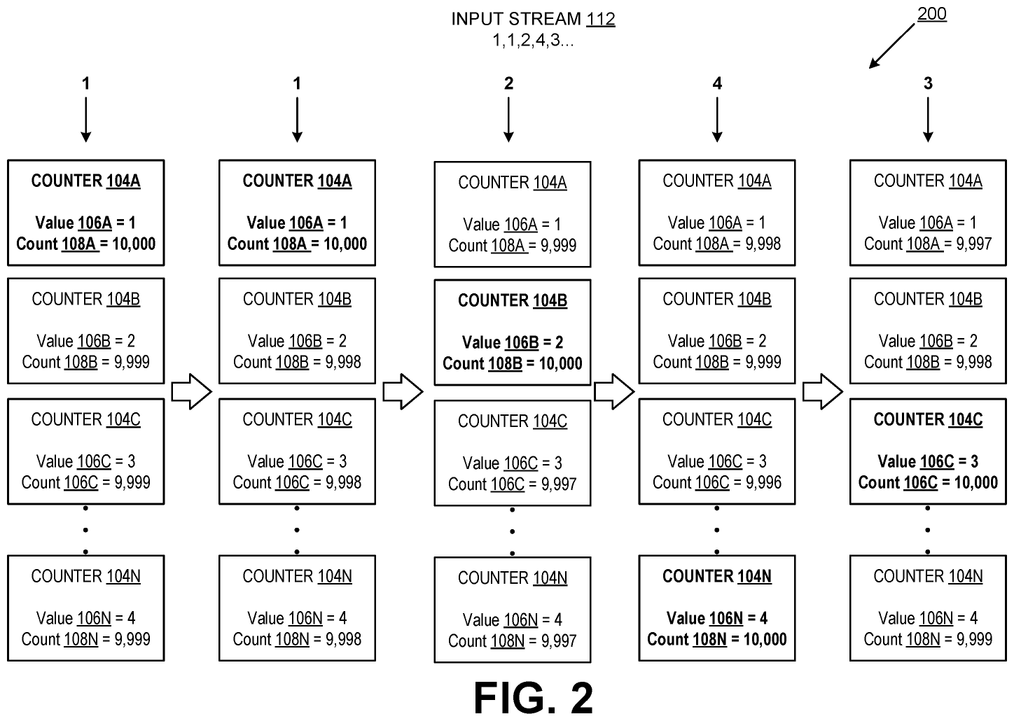

Decision logic 102 is operatively coupled to transmit signals to counters 104A-104N to reset counters 104A-104N based on the input stream 112. In at least one embodiment, decision logic 102 may transmit a signal to reset a respective counter of the counters 104A-104N corresponding to an individual input value received from the input stream 112. For example, in response to receiving a clock signal, each of the counters 104A-104N may decrement a respective count 108A-108N, and decision logic 102 may receive an input value from the input stream 112. Decision logic 102 can transmit a signal to a counter of the counters 104A-104N corresponding to the input value to reset a respective count 108A-108N. In at least one embodiment, counters 104A-104N can decrement based on a signal received from decision logic 102. For example, decision logic 102 can transmit a binary signal ‘1’ to cause a counter to reset and a binary signal ‘0’ to cause a counter to decrement. In response to receiving an indication (e.g., a binary signal of ‘1’) from the decision logic 102, the counters 104A-104N can reset to a designated value. The designated value, for example, can correspond to the window 120, as illustrated below with respect to FIG. 2.

In an illustrative example, FIG. 2 is a block diagram 200 illustrating updating counters 104A-104N based on input values received from input stream 112, according to at least one embodiment of the present disclosure. Decision logic (e.g., decision logic 102 of FIG. 1A) can receive input stream 112, where the first five input values of the input stream 112 are 1.1,2,4, and 3. The decision logic can receive a first input value of “1” from the input stream 112 and transmit a signal (e.g., ‘1’) to counter 104A to reset count 108A to 10,000 (window 120 of FIG. 1). The decision logic can transmit a signal (e.g., ‘0’) to counter 104B-104N to decrement a respective count. Accordingly, after receiving the first input value of “1” from input stream 112, count 108A is 10,000; count 108B is 9,999; count 108C is 9,999; and count 108N is 9,999.

The decision logic can receive a second input value of “1” from the input stream 112 and transmit a signal (e.g., ‘1’) to counter 104A to reset count 108A to 10,000. The decision logic can transmit a signal (e.g., ‘0’) to counters 104B-104N to decrement a respective count. Accordingly, after receiving the second input value of “1” from input stream 112, count 108A is 10,000; count 108B is 9,998; count 108C is 9,998; and count 108N is 9,998.

The decision logic can receive a third input value of “2” from the input stream 112 and transmit a signal (e.g., ‘1’) to counter 104B to reset count 108B to 10,000. The decision logic can transmit a signal (e.g., ‘0’) to counter 104A, 104C, and 104N to decrement a respective count. Accordingly, after receiving the third input value of “2” from input stream 112, count 108A is 9,999; count 108B is 10,000; count 108C is 9,997; and count 108N is 9,997.

The decision logic can receive a fourth input value of “4” from the input stream 112 and transmit a signal (e.g., ‘1’) to counter 104N to reset count 108N to 10,000. The decision logic can further transmit a signal (e.g., ‘0’) to counters 104A-104C to decrement a respective count. Accordingly, after receiving the fourth input value of “4” from input stream 112, count 108A is 9,998; count 108B is 9,999; count 108C is 9,996; and count 108N is 10,000.

The decision logic can receive a fifth input value of “3” from the input stream 112 and transmit a signal (e.g., ‘1’) to counter 104C to reset count 108C to 10,000. The decision logic can further transmit a signal (e.g., ‘0’) to counter 104A, counter 104B, and counter 104N to decrement a respective count. Accordingly, after receiving the fifth input value of “3” from input stream 112, count 108A is 9,997; count 108B is 9,998; count 108C is 10,000; and count 108N is 9,999.

FIG. 1B is a block diagram of an implementation of a system 130 illustrating another example of a technique for efficient computation of rolling window statistics, in accordance with at least one embodiment of the present disclosure. Illustrated is decision logic 102, counter 104A-104N, conditional logic 110, and a computation block 113. The decision logic 102 is operatively coupled to receive input stream 112. FIG. 1B specifically illustrates computing rolling window statistics after receiving five input values [1,1,2,4,3] from input stream 112, as illustrated above with respect to FIG. 2. After receiving the five input values from input stream 112, count 108A of counter 104A is 9,997; count 108B of counter 104B is 9,998; count 108C of counter 104C is 10,000; and count 108N of counter 104N is 9,999. Counters 104A-104N may include logic to transmit a signal to conditional logic 110 based on a respective count 108A-108N. In at least one embodiment, counters 104A-104N may transmit a binary sequence to conditional logic 110 based on whether a respective count 108A-108N is greater than zero. If the count 108A-108N is greater than zero, the respective counter 104A-104N may transmit a “1” to conditional logic 110. Thus, a signal of ‘1’ may represent that a corresponding value 106A-106N has been received from the input stream 112 within the window 120 (e.g., within 10,000 clock cycles/received values). If the count 108A-108N is equal to zero, the respective counter 104A-104N may transmit a signal ‘0’ to conditional logic 110. Thus, a signal of ‘0’ may represent that a corresponding value 106A-106N has not been received from the input stream 112 within the window 120.

In an illustrative example, counter 104A may determine that count 108A (9,997) is greater than zero and transmit a ‘1’ to conditional logic 110. Counter 104B may determine that count 108B (9,998) is greater than zero and transmit a ‘1’ to conditional logic 110. Counter 104C may determine that count 108C (10,000) is greater than zero and transmit a ‘1’ to conditional logic 110. Counter 104N may determine that count 108N is greater than zero and transmit a ‘1’ to conditional logic 110. Accordingly, counters 104A-104N may transmit a binary sequence ‘1111’ to conditional logic 110. The most significant bit (MSB) of the binary sequence can, for example, correspond to counter 104N, and the least significant bit (LSB) of the binary sequence can correspond to counter 104A.

Conditional logic 110 is operatively coupled to receive the binary sequence from counters 104A-104N. For example, conditional logic 110 can receive a binary sequence of ‘1111’ from counters 104A-104N. The conditional logic 110 can determine a minimum and/or maximum value received within the rolling window 120 (e.g., within the last 10,000 clock cycles) based on the binary sequence received from the counters 104A-104N. In at least one embodiment, to determine the maximum value, the conditional logic 110 may use a find first bitwise operation to iterate through the bits of the binary sequence from the MSB of the binary sequence to the LSB of the binary sequence to find the index of the most significant ‘1’ bit. For example, the conditional logic 110 can determine that the most significant ‘1’ bit of the binary sequence corresponds to counter 104N and, therefore, the maximum value received within the window 120 is four. To determine the minimum value, the conditional logic 110 may use a find first bitwise operation to iterate through the bits of the binary sequence from the LSB of the binary sequence to the MSB of the binary sequence to find the index of the least significant ‘1’ bit of the binary sequence. For example, the conditional logic 110 can determine that the least significant ‘1’ bit of the binary sequence corresponds to counter 104A and, therefore, the minimum value received within the window 120 is one.

Computation block 113 is operatively coupled to receive a minimum value and a maximum value from conditional logic 110. Computation block 113 may compute an average of the minimum value and the maximum value. For example, computation block 113 may receive a minimum value of ‘1’ and a maximum value of ‘4’ from conditional logic 110 and use a division operation to calculate an average value of ‘2.5,’ (i.e., (4+1)/2=2.5). In at least one embodiment, the computation block 113 may perform the division operation using a right shift bitwise operation. For example, the binary representation of 5 (i.e., 4+1) is ‘101.’ The computation block 113 can right shift ‘101’ by one position to obtain a binary value ‘010,’ dropping the LSB and adding a ‘0’ as the MSB. The binary value ‘010’ is equivalent to a decimal value of ‘2,’ which can be considered an approximation of the average of the maximum value and the minimum value. In at least one embodiment, computation block 113 can provide an output 114 including the maximum value received over the window 120, the minimum value received over the window 120, and/or the average of the maximum value and the minimum value. It is appreciated that in hardware implementations, the computation block 113 can perform division operations using a division circuit that can employ various techniques such as bit shifting, subtraction, comparison operations, and the like.

FIG. 1C is a block diagram the of an implementation of a system 140 illustrating another example of a technique for efficient computation of rolling window statistics, in accordance with at least one embodiment of the present disclosure. The system 140 includes decision logic 102, counter 104A-104N, conditional logic 110, and a computation block 113. The decision logic 102 is operatively coupled to receive input stream 112. FIG. 1C illustrates an example of a state of counters 104A-104N after many (e.g., 10,000 or more) input values have been received from input stream 112 and processed by system 140. As illustrated, count 108A of counter 104A is zero; count 108B of counter 104B is 10,000; count 108C of counter 104C is zero, and count 108N of 104N is 1. Because count 108A is zero, counter 104A can transmit a binary signal ‘0’ to conditional logic 110 to indicate that an input value of one has not been received from the input stream 112 within the window 120. Because count 108B is greater than zero, counter 104B can transmit a binary signal ‘l’ to conditional logic 110 to indicate that an input value of two has been received from the input stream 112 within the window 120. Because count 108C is zero, counter 104C can transmit a binary signal ‘0’ to conditional logic 110 to indicate that an input value of three has not been received from the input stream 112 within the window 120. Because count 108N is greater than zero, counter 104N can transmit a binary signal ‘1’ to conditional logic 110 to indicate that an input value of four has been received from the input stream 112 within the window 120. Accordingly, counters 104A-104N can transmit a binary sequence of ‘1010’ to conditional logic 110, where the MSB of the binary sequence corresponds to counter 104N and the LSB of the binary sequence corresponds to counter 104A.

Conditional logic 110 can be operatively coupled to receive the binary sequence of ‘1010’ from the counters 104A-104N. To determine a maximum value received within the window 120, the conditional logic 110 may use a find first bitwise operation to find the most significant ‘1’ bit of the binary sequence, as described above. For example, the conditional logic 110 can determine that the most significant ‘1’ bit of the binary sequence corresponds to counter 104N and, therefore, the maximum value received within the window 120 is four. To determine the minimum value, the conditional logic may use a find first bitwise operation to find the least significant ‘1’ bit, as described above. For example, the conditional logic 110 can determine that the least significant ‘1’ bit of the binary sequence corresponds to counter 104B and, therefore, the minimum value received within the window 120 is two. The computation block 113 can determine an average of the minimum value and the maximum value, as described above. For example, computation block 113 can determine the average of the minimum value and the maximum value is three using a right shift bitwise operation.

It can be noted that the systems and implementations described above with respect to FIG. 1A-1C can be implemented by processing logic that can include hardware (e.g., a processing device, processing circuitry, dedicated logic, microcode, hardware of a device, integrated circuit, etc.), software (e.g., instructions running or executing on a processing device), firmware, or a combination thereof. It is appreciated that alternative configurations of the systems described above can be considered without deviating from the scope of the present disclosure. For example, counters 104A-104N can be initialized to a count 108A-108N of zero and increment rather than decrement. Responsive to receiving a clock signal from the clock (or in response to receiving an indication from decision logic 102), the counters 104A-104N may increment a respective count 108A-108N of the counters 104A-104N beginning from an initialized value of zero. Responsive to receiving an input value from the input stream 112, decision logic 102 can transmit a signal to reset a respective counter of the counters 104A-104N to a designated value of zero, according to the input value. To determine whether a particular value has been received from the input stream within the window 120, a counter corresponding to the particular value may determine whether a respective count is less than the window 120. If the count is less than the window 120, the corresponding counter of counters 104A-104N can transmit a ‘1’ to conditional logic 110 to indicate that the particular value has been received within the window 120. If the count is not less than the window 120, the corresponding counter of counters 104A-104N can transmit a ‘0’ to conditional logic 110 to indicate that the particular value has not been received within the window 120.

In at least one embodiment, the window 120 may be equal to a maximum value of counters 104A-104N, as described above. In at least one embodiment, the maximum value of the counter may be greater than the window 120. For example, the maximum count of the counters 104A-104N can be 100,000 and the window 120 can be 10,000. In at least one embodiment, count 108A-108N can be reset (e.g., responsive to receiving a signal from decision logic 102) to a count corresponding to the window 120. In at least one embodiment, count 108A-108N can be reset to the maximum count. Count 108A-108N can be compared with respect to the window 120 to determine the maximum/minimum value received within the window 120. In at least one embodiment, window 120 is runtime configurable. Runtime configurable refers to the ability of a system or software to be adjusted or modified while it is operational without restarting or interrupting execution. For example, the size of window 120 can be modified (e.g., increased, decreased, etc.) dynamically (“on-the-fly”) to accommodate different scenarios without halting the system.

In at least one embodiment, input values may be received from the input stream 112 at inconsistent intervals of time. For example, a first input value may be received from input stream 112 after a first time interval, and a second input value may be received from the input stream 112 after a second time interval. In such an embodiment, the counters 104A-104N may be updated (i.e., decremented/incremented) and reset in response to receiving a signal from decision logic 102. For example, responsive to receiving an input value from input stream 112, decision logic 102 can transmit a signal to reset a count of a counter corresponding to the input value and can transmit signals to the other counters of the counter 104A-104N to increment/decrement a respective count 108A-108N. Accordingly, counters 104A-104N may be incremented/decremented in response to receiving a signal from decision logic 102 or in response to receiving a clock signal (where input values are received according to the clock signal).

In at least one embodiment, decision logic 102 can include logic to pre-process the input stream 112 in order to produce an output 114 at differing granularities. Input values received from the input stream 112 can be categorized according to certain criteria or rules. In an illustrative example, the stream of values can be placed into “buckets” representing specific ranges of input values prior to providing the values as input. For example, input stream 112 can include a range of input values from one to eight. Value 106A of counter 104A can include input values one and two, value 106B of counter 104B can include input values three and four, value 106C of counter 104C can include input values five and six, and value 106N of counter 104N can include input values seven and eight.

In at least one embodiment, a Dynamic Voltage and Frequency Scaling (DVFS) system may leverage the introduced technique described above to dynamically adjust an operating voltage and/or frequency of a device based on a workload to optimize power consumption while maintaining acceptable performance levels. To make effective DVFS adjustments, the DVFS system can rely on feedback mechanisms and metrics that provide information about a computational demand level of the device executing the workload. The metrics that provide information about the computational demand level of the device can include metrics such as CPU utilization (process-level and/or system-level), a power consumption level, memory usage, input/output (I/O) activity, a temperature level, and/or the like. In an illustrative example, the computational demand level of the workload of the device can be represented by a CPU utilization level of the device. The CPU utilization level can indicate the percentage of time the CPU spends executing non-idle tasks compared to total time over a specific period. Each input value of the input stream 112 can correspond to a CPU utilization level of the device executing the workload. For example, the input stream 112 can be a bounded range of CPU utilization levels from zero to seven, where eight represents that the CPU is running 100% of the time, zero represents a fully idle CPU, and one through six represents a linear scale of CPU utilization percentages between 0% utilization and 100% utilization. The DVFS system can leverage the output 114 (e.g., minimum CPU utilization level and/or the maximum CPU utilization) over a large period (e.g., over a window of 10,000 cycles) to determine whether to adjust a frequency and/or a voltage of the device.

In at least one embodiment, the DVFS system can leverage the minimum CPU utilization level to adjust a device sensitive to power consumption. For example, a client device (e.g., a cell phone) may be operating in a low-power mode. If the minimum CPU utilization level is below a certain threshold (e.g., three), the DVFS system can lower the supply voltage provided to components of the device and/or lower the operating frequency of the components of the device, reducing power consumption as a result. In at least one embodiment, the DVFS system can leverage the maximum CPU utilization level to adjust a device sensitive for performance. For example, if the maximum CPU utilization level is below a certain threshold (e.g., six), the DVFS system can lower the supply voltage provided to components of the device and/or lower the operating frequency of components of the device.

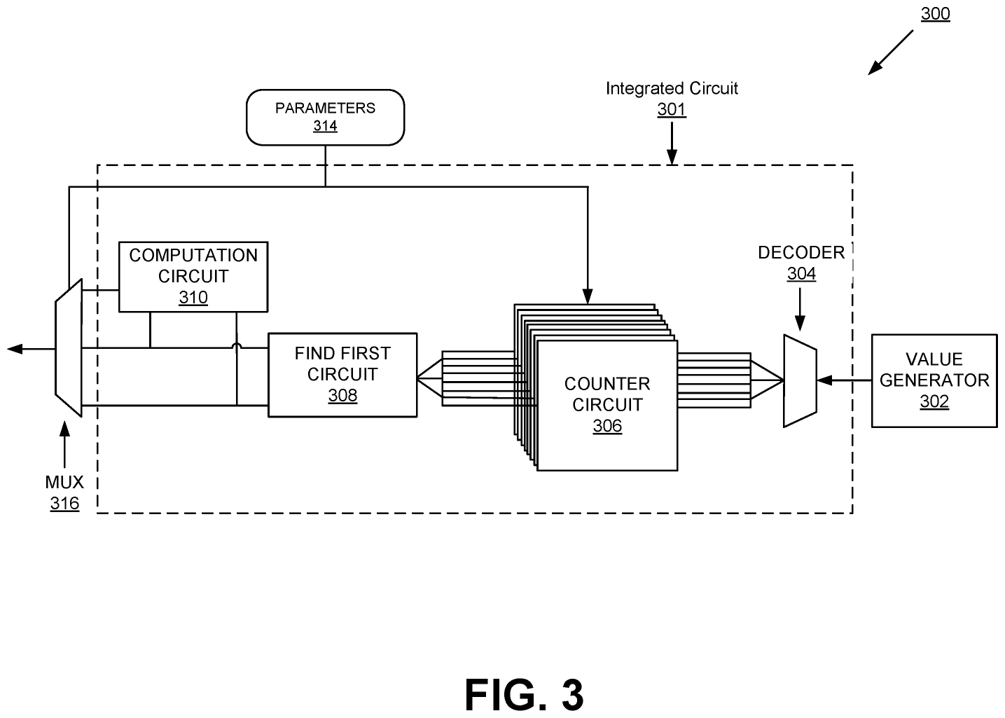

FIG. 3 is a block diagram of a hardware implementation of a system configuration, in accordance with at least one embodiment of the present disclosure. Illustrated is a system 300 including a value generator 302, an integrated circuit 301 (IC 301), a multiplexer 316 (MUX 316), and configurable parameters 314. The IC 301 includes a decoder 304, a counter circuit 306, a find first circuit 308, and a computation circuit 310.

The value generator 302 generates an input stream for input to the IC 301. The value generator 302 can include sensors, databases, computing engines (e.g., a deep learning accelerator (DLA)), memory devices (e.g., volatile memory, non-volatile memory, etc.), and the like. In at least one embodiment, the input stream received by the value generator 302 can be a stream of data, such as a stream of input values. In at least one embodiment, the input values within the input stream can be constrained by an exclusive list of possible values. For example, the input stream may be bounded by a range of possible values from zero to seven. Each possible value within the input stream can correspond to a counter of the counter circuit 306, where the counter tracks the corresponding value received from the input stream.

The decoder 304 is coupled to receive the input stream from the value generator 302. The decoder 304 can be a combinational circuit to demultiplex an input value from the input stream from one input line to multiple output lines. In an illustrative example, the decoder 304 can be a 3 to 8 line decoder to decode a three-bit binary value into eight outputs, where each output is provided as input to a respective counter of the counter circuit 306. A binary value of ‘1’ may be provided as input to a counter corresponding to the input value, and a binary value of ‘0’ may be provided as input to each of the counters of the counter circuit 306. For example, the decoder 304 can receive an input value of seven (binary value of ‘111’) from the input stream. The decoder 304 can decode ‘111’ to a binary sequence of ‘10000000,’ where the MSB of the binary sequence is provided to a counter corresponding to the input value of seven, and the other bits of the binary sequence are provided to the other counters respectively.

Each counter of the counter circuit 306 is coupled to receive an input from the decoder 304 and update a respective count based on the input. For example, counter circuit 306 may receive a binary sequence of ‘10000000’ from decoder 304, indicating that the input value received from the value generator 302 was a seven. A counter of the counter circuit 306 corresponding to an input value of seven may receive a ‘1’ from the decoder. Responsive to receiving ‘1’ from the decoder, the counter can reset (e.g., set to a maximum count, set to a window value, etc.) its count. For example, the counter can reset to a count corresponding to a given window (e.g., 10,000) over the value stream. Each of the other counters of the counter circuit 306 can update (increment or decrement) their respective counts.

In at least one embodiment, the counter circuit 306 can include logic to compare a count of each of the counters within the window of received values and transmit a binary sequence to the find first circuit 308 based on the comparison. For example, if a count is greater than zero, the respective counter may transmit a ‘1’ to the find first circuit 308, and if the count is equal to zero, the respective counter may transmit a ‘0’ to the find first circuit 308, as described above. For example, the counter circuit 306 may transmit a binary sequence of ‘10011000,’ where the raised bits (i.e., bits with a value of ‘1’) correspond to counters associated with values that have been received within the window, and the lowered bits (i.e., bits with a value of ‘0’) correspond to counters associated with values that have not been received within the window.

The find first circuit 308 is coupled to receive a binary sequence, such as the binary sequence ‘10011000,’ from the counter circuit 306. To determine a maximum value received within the window 120, the find first circuit 308 may use a find first bitwise operation to find the most significant ‘1’ bit of the binary sequence, as described above. For example, the conditional logic 110 can determine that the most significant ‘1’ bit of the binary sequence corresponds to a counter associated with the value seven and, therefore, the maximum value received within the window is seven. To determine the minimum value, find first circuit 308 may use a find first bitwise operation to find the least significant ‘1’ bit, as described above. For example, the find first circuit 308 can determine that the least significant ‘1’ bit of the binary sequence corresponds to a counter associated with the value of three and, therefore, the minimum value received within the window 120 is three.

The computation circuit 310 is coupled to receive the minimum value and the maximum value from the find first circuit 308. The computation circuit 310 can determine an average of the minimum value and the maximum value. For example, computation circuit 310 can determine the average of the minimum value and the maximum value is five (average of seven and three) using a right shift bitwise operation. It is appreciated that the computation circuit 310 can be a division circuit that employs various techniques such as bit shifting, subtraction, comparison operations, and the like to determine the average of the minimum value and the maximum value.

The multiplexer 316 (MUX 316) is coupled to receive the minimum value and maximum value from the find first circuit 308 and the average of the minimum value and the maximum value from the computation circuit 310. The MUX 316 can provide one or more of the minimum value, the maximum value, or the average of the minimum value and the maximum value as an output of the system 300.

In at least one embodiment, the system 300 can include configurable parameters 314. The configurable parameters 314 can determine a window over the stream of values in which the IC 301 determines the minimum value, the maximum value, and the average of the minimum value and the maximum value. The counter circuit 306 can be reconfigured according to the window. In at least one embodiment, the window can be runtime configurable, as described above. The configurable parameters 314 can be determined, for example, based on a user input into the system 300.

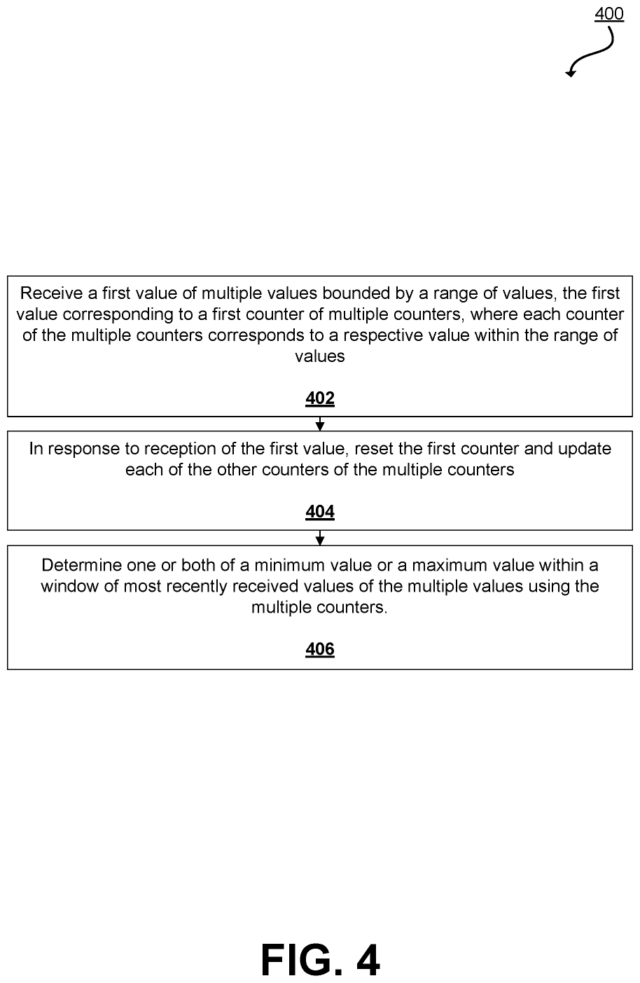

FIG. 4 depicts a flow diagram of an example method 400 of efficient computation of rolling window statistics, in accordance with at least one embodiment of the present disclosure. The method 400 can be performed by processing logic that can include hardware (e.g., a processing device, processing circuitry, dedicated logic, microcode, hardware of a device, integrated circuit, etc.), software (e.g., instructions running or executing on a processing device), firmware, or a combination thereof. In at least one embodiment, the method 400 can be performed by a non-transitory computer-readable medium comprising instructions that, responsive to execution by a processor, cause the processor of a computing system to perform operations described herein. In at least one embodiment, some or all the operations of method 400 can be performed by one or more components of system 100 of FIG. 1A, system 130 of FIG. 1B, and/or system 140 of FIG. 1C. In at least one embodiment, some or all of the operations of method 400 can be performed by IC 301 of FIG. 3.

For simplicity of explanation, the methods are depicted and described as a series of acts. However, acts in accordance with this disclosure may occur in various orders and/or concurrently with other acts not presented and described herein. Furthermore, not all illustrated acts may be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 402 of method 400, processing logic receives a first value of multiple values, such as input stream 112, bounded by a range of values. The first value corresponds to a first counter of multiple counters, such as counters 104A-104N, where each counter of the multiple counters corresponds to a respective value within the range of values.

At operation 404, in response to reception of the first value, processing logic resets the first counter and updates each of the other counters of the multiple counters. In at least one embodiment, to reset the first counter, processing logic can update a first count of the first counter to a designated value. In at least one embodiment, the designated value corresponds to a number of values within the window of most recently received values. In at least one embodiment, to update each of the other counters, the processing logic can decrement a respective count of each of the other counters.

At operation 406, processing logic determines one or both of a minimum value within a window, such as window 120, of most recently received values of the multiple values using the multiple counters. In at least one embodiment, to determine the minimum value, the processing logic can identify the minimum value within the range of values corresponding to a second counter of the multiple counters with a second counter above a threshold count. In at least one embodiment, to determine the maximum value, the processing logic can identify the maximum value within the range of values corresponding to a second counter of the multiple counters with a second count above a threshold count. The threshold count, for example, can be zero, as described above with respect to FIG. 1A-1C.

In at least one embodiment, the processing logic can further determine an average of the minimum value and the maximum value. In at least one embodiment, the multiple values correspond to a computational demand level of a workload of a device. The processing logic can further adjust one or both of an operating frequency or an operating voltage of the device based on one or more of the minimum value, the maximum value, or the average of the minimum value and the maximum value.

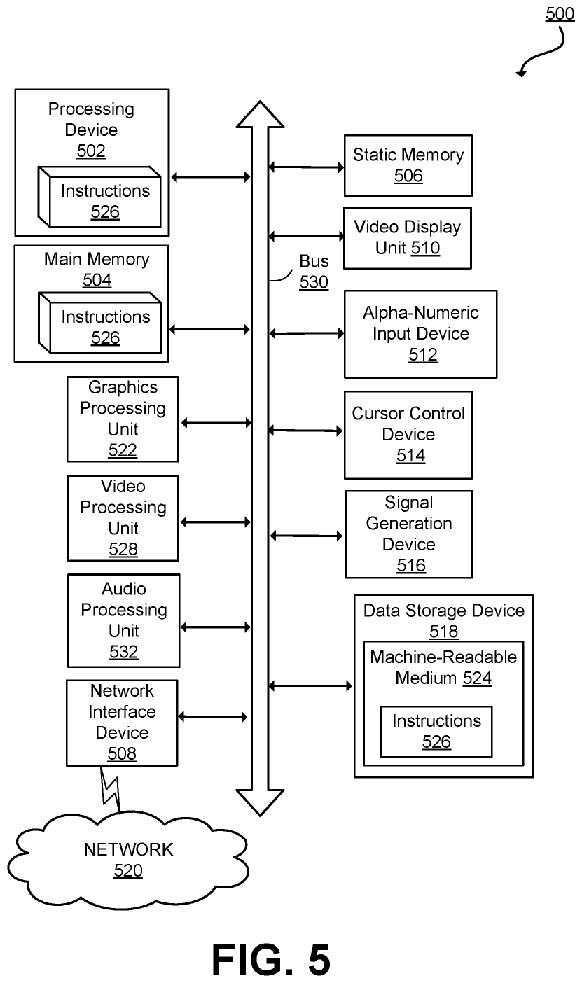

FIG. 5 illustrates an example machine of a computer system 500 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in a client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random-access memory (DRAM) such as synchronous DRAM (SDRAM), a static memory 506 (e.g., flash memory, static random access memory (SRAM), etc.), and a data storage device 518, which communicate with each other via a bus 530.

Processing device 502 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 may also be one or more special-purpose processing devices such as an application-specific integrated circuit (ASIC), a field-programmable gate array (FPGA), a digital signal processor (DSP), a network processor, or the like. The processing device 502 may be configured to execute instructions 526 for performing the operations and steps described herein.

The computer system 500 may further include a network interface device 508 to communicate over the network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), a graphics processing unit 522, a signal generation device 516 (e.g., a speaker), graphics processing unit 522, video processing unit 528, and audio processing unit 532.

The data storage device 518 may include a machine-readable storage medium 524 (also known as a non-transitory computer-readable medium) on which is stored one or more sets of instructions 526 or software embodying any one or more of the methodologies or functions described herein. The instructions 526 may also reside, completely or at least partially, within the main memory 504 and/or within the processing device 502 during execution thereof by the computer system 500, the main memory 504 and the processing device 502 also constituting machine-readable storage media.

In some implementations, the instructions 526 include instructions to implement functionality corresponding to the present disclosure. While the machine-readable storage medium 524 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine, allowing the machine and the processing device 502 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform a similar sequence of procedures. In addition, the present disclosure is not described with reference to any particular programming language, and any one in use in such computer systems may be used to implement the teachings of the disclosure as described herein.

The present disclosure may be provided as a computer program product, or software, that may include a non-transitory computer-readable storage medium (CRM) having stored thereon instructions, which may be used to program a computer system (or other electronic devices) to perform a process according to the present disclosure. A CRM includes any mechanism for storing information in a form readable by a machine (e.g., a computer). For example, a CRM includes a machine (e.g., a computer) readable storage medium such as read-only memory (“ROM”), random-access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element may be depicted in the figures and like elements are labeled with like numerals. The disclosure and drawings are, accordingly, to be regarded in an illustrative sense rather than a restrictive sense.

What is claimed is:

1. A method comprising:
receiving a first value of a plurality of values bounded by a range of values, the first value corresponding to a first counter of a plurality of counters, wherein each counter of the plurality of counters corresponds to a respective value within the range of values;
responsive to receiving the first value, resetting the first counter and updating each of the other counters of the plurality of counters; and
determining one or both of a minimum value or a maximum value within a window of most recently received values of the plurality of values using the plurality of counters.

2. The method of claim 1, wherein resetting the first counter comprises updating a first count of the first counter to a designated value.

3. The method of claim 2, wherein the designated value corresponds to a number of values within the window of the most recently received values.

4. The method of claim 1, wherein updating each of the other counters comprises decrementing a respective count of each of the other counters.

5. The method of claim 1, wherein determining the minimum value comprises identifying the minimum value within the range of values corresponding to a second counter of the plurality of counters with a second count above a threshold count.

6. The method of claim 1, wherein determining the maximum value comprises identifying the maximum value within the range of values corresponding to a second counter of the plurality of counters with a second count above a threshold count.

7. The method of claim 1, furthering comprising determining an average of the minimum value and the maximum value.

8. The method of claim 7, wherein each of the plurality of values corresponds to a computational demand level of a workload of a device, and further comprising adjusting one or both of an operating frequency or an operating voltage of the device based on one or more of the minimum value, the maximum value, or the average of the minimum value and the maximum value.

9. An apparatus comprising:
a plurality of counters; and
circuitry, operatively coupled to the plurality of counters, wherein the circuitry is to:
receive a first value of a plurality of values bounded by a range of values, the first value corresponding to a first counter of a plurality of counters, wherein each counter of the plurality of counters corresponds to a respective value within the range of values;
responsive to a reception of the first value, reset the first counter and update each of the other counters of the plurality of counters; and
determine one or both of a minimum value or a maximum value within a window of most recently received values of the plurality of values using the plurality of counters.

10. The apparatus of claim 9, wherein to reset the first counter, the circuitry is to update a first count of the first counter to a designated value.

11. The apparatus of claim 10, wherein the designated value corresponds to a number of values within the window of the most recently received values.

12. The apparatus of claim 9, wherein to update each of the other counters, the circuitry is to decrement a respective count of each of the other counters.

13. The apparatus of claim 9, wherein to determine the minimum value, the circuitry is to identify the minimum value within the range of values corresponding to a second counter of the plurality of counters with a second count above a threshold count.

14. The apparatus of claim 9, wherein to determine the maximum value, the circuitry is to identify the maximum value within the range of values corresponding to a second counter of the plurality of counters with a second count above a threshold count.

15. The apparatus of claim 9, wherein the circuitry is further to determine an average of the minimum value and the maximum value.

16. The apparatus of claim 15, wherein each of the plurality of values corresponds to a computational demand level of a workload of a device, and wherein the circuitry is further to adjust one or both of an operating frequency or an operating voltage of the device based on one or more of the minimum value, the maximum value, or the average of the minimum value and the maximum value.

17. An integrated circuit (IC) comprising:
a first circuit comprising a plurality of counters, wherein each counter of the plurality of counters corresponds to a respective value within a range of values, the first circuit to:
receive a first value of the plurality of values, the first value corresponding to a first counter of the plurality of counters;
responsive to a reception of the first value, reset the first counter and update each of the other counters of the plurality of counters; and
a second circuit, operatively coupled to the first circuit, the second circuit to determine one or both of a minimum value or a maximum value within a window of most recently received values of the plurality of values using the plurality of counters of the first circuit.

18. The IC of claim 17, wherein to reset the first counter, the first circuit is to update a first count of the first counter to a designated value, wherein the designated value corresponds to a number of values within the window of the most recently received values.

19. The IC of claim 17, wherein to update each of the other counters, the first circuit is to decrement a respective count of each of the other counters.

20. The IC of claim 17, further comprising a third circuit operatively coupled to the second circuit, wherein the third circuit is to determine an average of the minimum value and the maximum value.
